(19) United States
(12) Patent Application Publication
(10) Pub. No.: US 2018/0264700 A1
(43) Pub. Date: Sep. 20, 2018

(54) CLAMPING UNIT OF AN INJECTION MOLDING MACHINE HAVING COLUMNS

(71) Applicant: KraussMaffei Technologies GmbH, München (DE)

(72) Inventors: DANIEL AMMER, München (DE); PATRICK SCHWEISSTHAL, München (DE)

(73) Assignee: KraussMaffei Technologies GmbH, 80997 München (DE)

(21) Appl. No.: 15/544,450

(22) PCT Filed: Dec. 17, 2015
(86) PCT No.: PCT/EP2015/080189

§ 371 Date: Jul. 18, 2017

(30) Foreign Application Priority Data
Feb. 4, 2015 (DE) 10 2015 101 570.6

(51) Int. Cl. B29C 45/67; F15B 15/26

(52) U.S. Cl. CPC B29C 45/6728; B29C 2045/6757; F15B 15/262

(57) ABSTRACT

A clamping unit of an injection molding machine having platens and columns includes a clamping-type locking apparatus by which a column is securable in relation to one of the platens at any position along a travel path of the platens relative to one another. The clamping-type locking apparatus includes a clamping jacket and a clamping device for clamping-type locking of the column in relation to the clamping jacket. The clamping device is displaceable together with the column along the travel path within the clamping jacket, when the clamping device assumes a released state, and the clamping device is configured to effect a clamping action by generating between the clamping jacket and the clamping device a locking force which is directed radially outwards in relation to a longitudinal axis of the column.

The invention relates to a clamping unit of an injection molding machine having columns according to the preamble of claim 1.

It is, for example, known in the art to equip a clamping unit for a two-platen injection molding machine with short-stroke cylinders, e.g., pressure pads for producing the clamping force, and to mechanically implement the locking action between a column and a platen for transferring the clamping force. In this case, it is customary to realize a locking in particular by a form fit, with the columns having, in a certain region, teeth into which locking means can swing or pushed in so as to establish a form fit between a platen and the column.

Such a hydro-mechanical principle has established itself and has been proven as standard for high clamping forces. In the range of small clamping forces, such a system has cost disadvantages, since a great number of components is necessary for forming the locking actions. Swinging or pushing the locking elements inwards requires furthermore a certain degree of cycle time, which is undesirable.

In addition, a fully hydraulic operating principle has also been established for a clamping unit of an injection molding machine and involves a purely hydraulic action both to move the platens in relation to one another, the clamping force buildup, and to effect the locking action. This principle has as advantage a small number of components. However, it is disadvantageous that, as a result of the need for a high amount of oil (long oil column), significant drawbacks have to be accepted in terms of energy consumption. The reason for that is, i.a. the need to carry along the high oil quantity (oil column) during movement and to compress the oil column during the clamping force buildup.

WO 2010/109374 A1 discloses a locking device for columns of injection molding machines, based on a wedge-type clamping principle. A clamping sleeve is arranged in a clamping jacket and interacts, on one hand, with the column to be clamped and, on the other hand, with an actuating sleeve via a wedge surface and/or conical surface. The actuating sleeve is hydraulically shiftable to a small extent within the clamping jacket, so that a column which is shiftable in the released state with respect to the clamping sleeve can be held in a clamped manner with respect to the clamping device during actuation of the actuating sleeve.

Such a clamping apparatus has the drawback that the movement of the column can cause various types of contaminations, e.g., water, cooling water, dirt, grease, release agent and the like can migrate between the clamping sleeve and the column region to be clamped, so that loss due to unwanted frictional force or excessive wear can occur between the clamping sleeve and the column. In such a case, it is not always ensured that the locking force is sufficiently high to maintain the required clamping force, or the life of the apparatus is substantially shortened due to wear processes.

A mold clamping head of the FSK type is known from the technical information document TI-P11-DE-05/2013 from the company Sitema GmbH & Co. KG, and can be used as a hydraulically actuated clamping device for fixing a platen with respect to a column of an injection molding machine. This mold clamping head utilizes the wedge-type clamping principle with a clamping sleeve and an actuating sleeve, with the clamping head being shiftable relative to the column along the travel path together with the platen onto which the mold clamping head is attached, and capable to build up radially inwardly acting locking forces with respect to the column in the event of a clamping. Such a mold clamping head has the same disadvantages as described above with regard to WO 2010/109374 A1 There is a risk of contamination of the friction surface between the clamping sleeve and the corresponding surfaces of the column.

Object of the invention is to provide a clamping unit with a clamping-type locking apparatus which permits, on one hand, to keep a diameter of the column to be fixed as small as possible and still to produce sufficiently high frictional forces. On the other hand, provision shall be made for the clamping-type locking apparatus to be insensitive to external environmental influences, e.g. oil leaks, cooling water, deposits, dust, grease or other dirt that may come into contact with the column.

Furthermore, a particular embodiment of the invention shall have minimal exposure to wear.

In addition, the number of required components shall be minimal and, in particular, low energy consumption should be realized.

Furthermore, the operational safety of the system shall be significantly enhanced in comparison to existing frictionally-locked clamping-type locking apparatuses and/or a time requirement for establishing a sufficient fixing of the platens in comparison to mechanical systems shall be significantly reduced.

These objects are achieved by a clamping unit having the features of claim 1. Advantageous embodiments are set forth in the subclaims.

A clamping unit according to the invention of an injection molding machine with columns has at least one clamping-type locking apparatus, in particular a clamping unit of a two-platen injection molding machine, and includes according to the invention at least one column which can be secured by means of the clamping-type locking apparatus with respect to one of the platens, and at least one clamping device for locking the at least one column with respect to a clamping jacket at any positions along a travel path of a first platen relative to a second platen. According to the invention, such a clamping unit is characterized in that, in the released state, the clamping device is displaceable together with the column along the travel path within the clamping jacket and a locking force which is radially outwardly directed in relation to a column longitudinal axis can be effected between the clamping jacket and the clamping device by means of the clamping device.

With such a configuration according to the invention of the clamping unit or its clamping-type locking apparatus, it is possible to keep the column diameter as small as possible, since an outer side of the column is not required for generating a sufficiently high locking force. Rather, according to the invention, the clamping device is designed in such a way as to form a locking force which is directed radially outwards towards the surrounding clamping jacket. The clamping jacket surrounds the clamping device on the outside and thus has a greater inner diameter relative to the column, thereby enlarging the inner peripheral surface that is a partial surface of the clamping jacket and is available for clamping.

Furthermore, the clamping jacket is arranged encapsulating around the column over the entire length of the distance required for the travel path, so that the column and the clamping device is located inside the clamping jacket and thus removed in a positive manner from exposure to unwanted dirt or other deposits, like e.g. oil, grease, cooling water or the like. This ensures, in particular, the long-term operational safety, since the frictional contact between the clamping device and the inner side of the clamping jacket, which preferably is tubular in shape, can be held lastingly free of contamination.

For this purpose, provision is made in particular for a stripping device in a region before a column section enters into the interior of the clamping jacket to wipe off undesired dirt and/or grease and/or cooling water and/or deposits, like e.g. dust or oil leakage, from the column. Such contaminations can reach the outer side of the column, when partial regions of the column are outside of the clamping jacket, for example, when the tool is fully open.

It has proven to be of advantage to form the clamping jacket as a grease-tight and/or dirt-tight tubular body.

According to a first structural variant, the clamping jacket can be made stationary in relation to a platen, i.e. in relation to the fixed platen or in relation to the moving platen. At the same time, it is also possible for the clamping jacket to be connected to the platen with the interposition of a pressure cylinder or a pressure pad. In this embodiment, the clamping jacket can act on one end as a piston of the pressure cylinder or the pressure pad or can be in direct operative contact thereto, for example via a tie rod/push rod.

It is preferred that an interior of the clamping jacket is filled with air or oil. It has been found that an equally reliable clamping can be attained with an oil filling. An air filling is advantageous because flushing loss is minimized when air in the clamping jacket is moved around from the one side of the clamping element to the other side of the clamping element.

In a preferred manner, the clamping device can have at least one pressure chamber which can be hydraulically supplied with fluid, wherein the at least one pressure chamber of the clamping device can be expanded radially elastically by fluid under pressure for generating the locking force. A radially elastically expanded state ensures hereby a clamping via an outer peripheral surface of the clamping device with an inner side of the clamping jacket. When a fluid pressure is reduced, an effective outside diameter of the clamping device decreases in relation to the inner side of the clamping jacket and thus again liberates the clamping device from the clamping jacket so as to be able to move again in relation to the clamping jacket.

According to a further advantageous embodiment, the clamping device is designed as a hydraulically actuatable wedge-type clamping apparatus with a clamping sleeve and an actuating sleeve, with the actuating sleeve being arranged within a housing of the clamping device and hydraulically shiftable in an axial direction and interacting with the clamping sleeve via a wedge or conical surface.

For the embodiment of the clamping device as wedge-type clamping device, there is the advantageous option to provide the clamping device with an open clamping chamber that points radially inwardly towards the column, and to enable the housing of the clamping device to be expanded elastically by reaction forces of the part clamping device radially with respect to its outside diameter.

According to another embodiment, the clamping device includes an open clamping chamber which points radially outwards towards the clamping jacket and in which the clamping sleeve is arranged for frictional interaction with an inner side of the clamping jacket. By means of an actuating sleeve, which interacts with the clamping sleeve via a wedge or conical surface, the diameter of the clamping sleeve can be reduced and increased, wherein the clamping action toward the outwardly surrounding clamping jacket can be made ineffective, when the diameter is reduced.

The invention thus for the first time pursues the approach to render the clamping device together with the column movable, especially shiftable, in the released state along the travel path, especially the entire travel path, rather than rendering the column movable in relation to the clamping device in the released state, so as to establish a clamping between the clamping jacket and the clamping device along an effective diameter which is greater than the column diameter. This makes it possible, on one hand, to keep the column diameter to a minimum and, on the other hand, to use the clamping jacket, which is also effective as an encapsulation, as clamping partner.

Further advantageous embodiments are specified in further patent claims or the following description of exemplary embodiments.

In the following, the invention is explained in more detail by way of example with reference to the drawing. It is shown in:

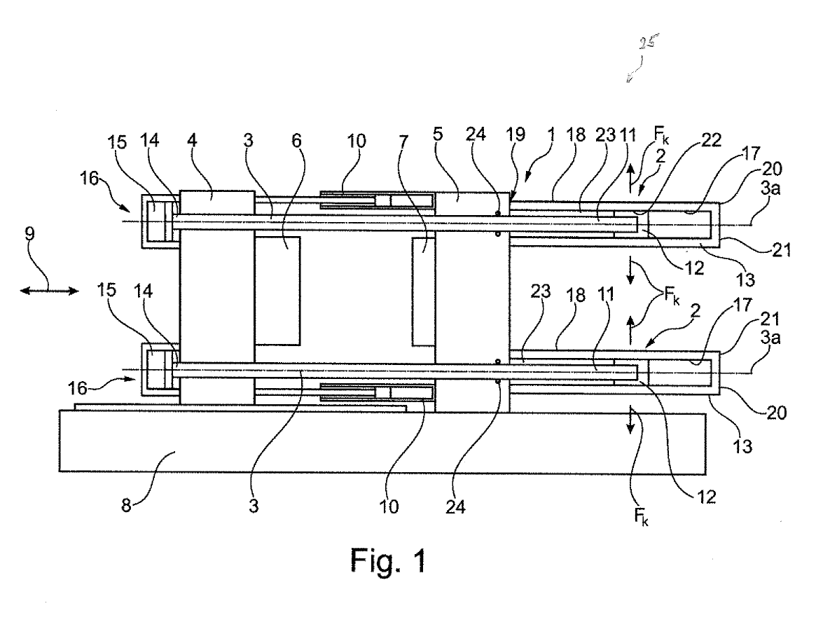

FIG. 1: a schematic side view of a clamping unit of an injection molding machine in accordance with the invention, comprising a first embodiment of a clamping-type locking apparatus according to the invention;

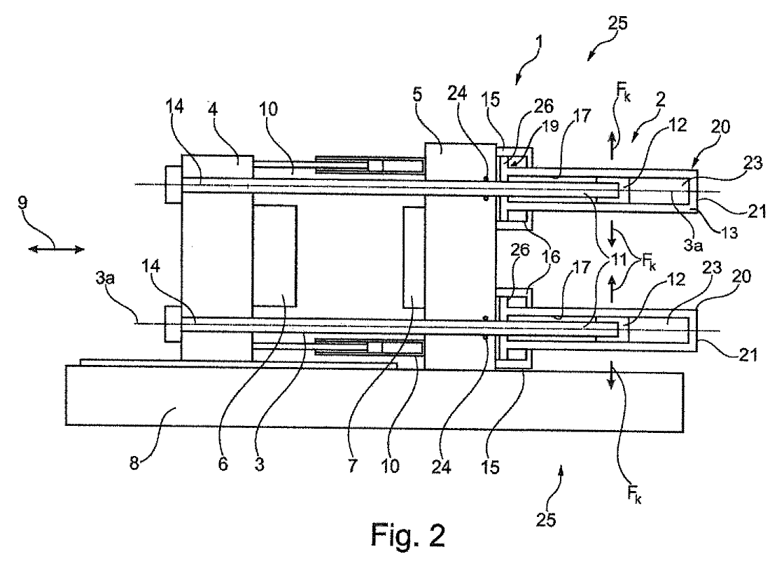

FIG. 2: a schematic side view of a clamping unit of an injection molding machine in accordance with the invention, comprising a second embodiment of a clamping-type locking apparatus according to the invention;

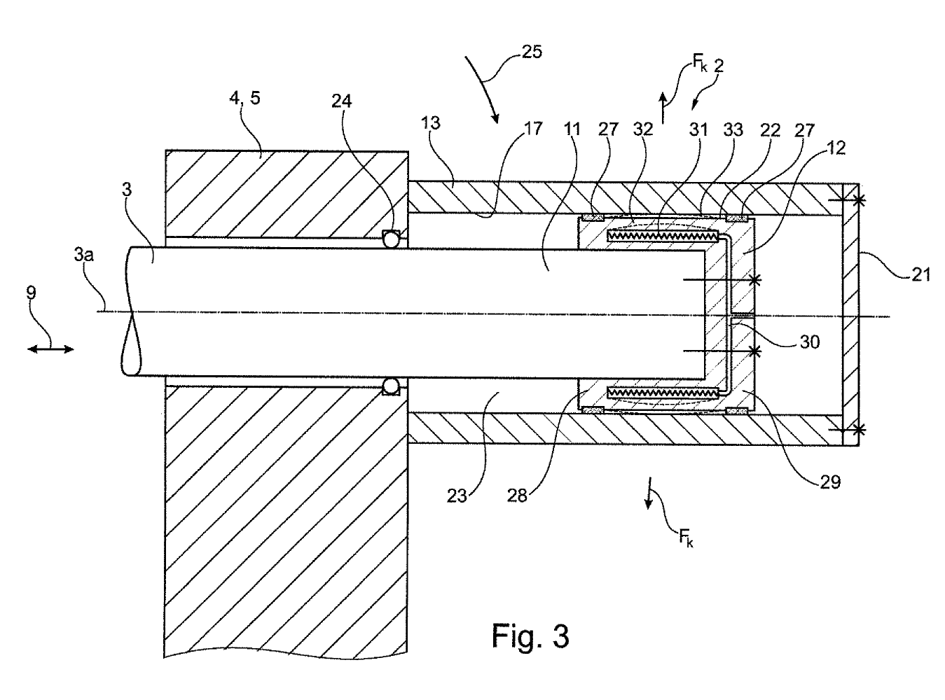

FIG. 3: a schematic longitudinal section of a first embodiment of a clamping device of the clamping-type locking apparatus;

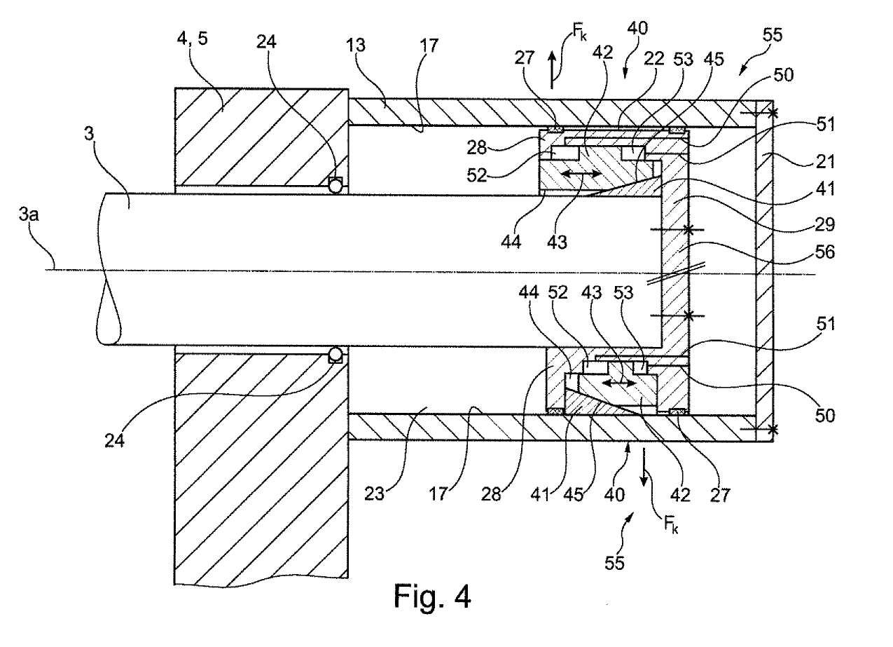

FIG. 4: in the upper sectional representation a second embodiment and in the lower sectional representation a third embodiment of the clamping device of a clamping-type locking apparatus, both utilizing the wedge-type clamping principle.

FIG. 1 shows a clamping unit 25 of an injection molding machine 1 in accordance with the invention with a clamping-type locking apparatus 2 according to the invention. The injection molding machine 1 has columns 3, with a clamping-type locking apparatus 2 being associated to each of the columns. The injection molding machine 1 includes a first platen 4 and a second platen 5, with a first half-mold 6 being arranged on the first platen 4 and a second half-mold 7 being arranged on the second platen 5. In the exemplary embodiment according to FIG. 1, the first platen 4 is the moving platen. The second platen 5 is the fixed platen. The moving first platen 4 is movably mounted relative to a machine bed 8 in an opening and closing direction 9 by means of displacement cylinders 10. The embodiment of the injection molding machine 1 shown in FIG. 1 is, of course, not limited to displacement cylinders 10 for opening and closing the platens 4, 5. Rather, other drives, like e.g. toggle lever drives or other linear drives for opening and closing the platens 4, 5 are appropriate as well.

Each of the columns 3 has a column longitudinal axis 3a. A clamping device 12 is located at a first end 11 of the columns 3 and is movably mounted in an associated clamping jacket 13 in the released state along the opening and closing direction 9. Pressure cylinders 15 are preferably arranged on a second end 14 of the columns and may be configured in particular as pressure pads 16. The pressure cylinders 15, in particular the pressure pads 16, are intended in a known manner to buildup the clamping force, when the platens 4, 5 have moved towards each other by means of the displacement cylinders 10 so that the half-molds 6,7 abut one another.

The clamping device 12 is capable to generate in relation to the column longitudinal axis 3a radially outwardly directed locking forces Fₖ, which are supported on an inner side 17 of the clamping jacket 13. The clamping jacket 13 is preferably configured as a tubular body 18 which, e.g. has a circular or, optionally, also a square or rectangular cross-section. The clamping jacket 13 is secured with a first end 19 to the second platen 5. At a second end 20, the clamping jacket 13 is closed and has an end wall 21. With regard to the longitudinal extent between the first end 19 and the second end 20 or the end wall 21, the clamping jacket 13 is configured such as to be capable to surround the clamping device 12 and the column 3 along the entire travel path along the opening and closing direction 9.

In the clamping-type locking apparatus 2 according to the invention, the clamping device 12 is firmly connected to the associated column 3 and, in the released state of the clamping device 12, is shiftable within the clamping jacket 13 together with the first end 11 of the column along the entire travel path in the opening and closing direction 9.

Thus, an encapsulated clamping-type locking apparatus 2 is provided, which remains free of dirt during operation of the injection molding machine 1. The encapsulation ensures that the inner side 17 of the clamping jacket 13 and a radially outer peripheral surface 22 of the clamping device 12 are able to effect a reliable clamping or blockage of the column 3 in relation to the clamping jacket 13 at any application of the locking force Fₖ, because the interacting surfaces (peripheral surface 22; inner side 17) remain effectively spared from contamination.

In order to prevent dirt to migrate into an interior space 23 of the clamping jacket 13 via the column 3 during travel of the platens 4, 5 along the opening and closing direction 9, stripping devices 24 are suitably provided, which are arranged, e.g., within a through-opening of the second platen 5 for passage of the column 3. The stripping devices 24 cooperate hereby with an outer side of the columns 3 and clean them before the column can reach the interior space 23 of the clamping jacket 13.

The clamping-type locking apparatus 2 according to the invention is thus formed at least by the clamping jacket 13, the clamping device 12, and a respectively associated column 3. One or more clamping-type locking apparatuses 2 according to the invention form together with one or more pressure cylinders 15 or pressure pads 16 a clamping unit 25, which ensures a reliable locking of the platens 4, 5 on one hand, and application of sufficiently high clamping forces via the pressure cylinders 15 or the pressure pads 16 on the other hand.

FIG. 2 shows a clamping unit 25 according to the invention of an injection molding machine 1, comprising at least a clamping-type locking apparatus 2 according to the invention, with the clamping-type locking apparatus 2 being coupled via pressure cylinders 15 or pressure pads 16 to the second platen 5.

In this embodiment of a clamping unit 25 of an injection molding machine 1, a plurality of identical or only slightly modified components are present compared to the embodiment according to FIG. 1, so that same reference signs are used in the following for same parts and the description will center on the differences to the embodiment according to FIG. 1. Moreover, features which are described in connection with an embodiment of the injection molding machine 1 according to FIG. 1 can be easily transferred to an injection molding machine 1 according to FIG. 2.

In contrast to the embodiment according to FIG. 1, the second end of the columns 3 is firmly secured, i.e. without interposition of a pressure pad 16 or a pressure cylinder 15, to the first platen 4. The second end of the clamping jacket 13 is accommodated inside the pressure cylinder 15 or pressure pad 16 and acts as a hydraulic piston of the pressure cylinder 15 or of the pressure pad 16. As the clamping force builds up, much smaller travel paths of the clamping jacket 13 within the pressure cylinder 15 or the pressure pad 16 are established primarily because of elastic deformation in comparison to the travel path in the opening and closing direction 9. In this embodiment, the clamping jacket 13 is movably mounted in relation to the second platen 5 within these elastically caused small travel paths. When a locking force Fₖ is applied by the clamping device 12, each column 3 is fixed within the associated clamping jacket 13. By applying hydraulic pressure within the pressure cylinder 15 or the pressure pad 16, the clamping force can build up for clamping the molding tool (first half-mold 6 and second half-mold 7) as a result of slight displacement of the clamping jacket 13 relative to the second platen 5, caused in particular by elastic deformation of the overall arrangement.

Like in the embodiment according to FIG. 1, the stripping devices 24 can suitably be placed in a through-opening of the columns 3 of the second platen 5. As an alternative or in addition, these stripping devices 24 may also be placed in a through-opening of a bottom wall 26 of the clamping jacket 13 for passage of the column 3 in this embodiment.

The bottom wall 26 can, for example, serve as a hydraulic piston of the pressure cylinder 15 or of the pressure pad 16 and configured accordingly.

The advantages described in connection with FIG. 1 with respect to the encapsulation and the reduced or prevented contamination of the interior space 23 equally apply to the embodiment according to FIG. 2. In addition, the embodiment according to FIG. 2 offers a very compact structure, since the clamping-type locking apparatus 2 together with the pressure cylinders 15 or the pressure pads 16 can be constructed as a preassembled unit, so that the entire clamping unit 25 is compact and permits a modular preassembly.

The interior space 23 of the clamping-type locking apparatus 2 according to the invention can be filled with air or oil. It has been found that also an oil filling is suitable for high reproducibility and for sufficiently high clamping forces Fₖ. Within the scope of the invention, it has been recognized that it is particularly important to keep moisture, dust, dirt and, in particular, grease away from the interacting surfaces for the locking force buildup of the clamping force Fₖ. The interacting surfaces involve hereby in particular the inner side 17 of the clamping jacket 13 and the peripheral surface 22 of the clamping device 12.

A first embodiment of the clamping device 12 of the clamping-type locking apparatus 2 according to the invention is shown schematically by way of a longitudinal section in FIG. 3.

The column 3 with its column longitudinal axis 3a extends through a platen 4, 5. The stripping device 24 is situated in the platen 4, 5. The clamping jacket 13 is firmly arranged on the platen 4, 5, so that the embodiment according to FIG. 3 corresponds to the arrangement according to FIG. 1 with respect to an injection molding machine 1. The clamping-type locking apparatus 2 according to FIG. 3 is, of course, also applicable to an injection molding machine 1 according to FIG. 2.

Furthermore, for all embodiments, the clamping-type locking apparatus 2 according to the invention can selectively be arranged on a fixed or a moving platen 4, 5.

At the first end 11 of the column 3, the clamping device 12 is firmly attached, for example, by means of a screw connection. The clamping device 12 has a substantially cup-shaped three-dimensional shape and is placed on the end of the first end 11 of the column 3 and is displaceable in the opening and closing direction 9 within the clamping jacket 13, when the clamping device 12 assumes the released state (solid lines of FIG. 3). The clamping device 12 has sliding devices, for example sliding rings 27, on its peripheral surface 22 for slidingly guiding the clamping device 12 on the inner side 17 of the clamping jacket 13 in the released state. The clamping device 12 has a cup-shaped wall 28, which is arranged in the region of the first end 11 between the column 3 and the clamping jacket 13. Furthermore, the clamping device 12 has a cup-shaped bottom 29 which rests with its inner side against a free end face of the column 3. The cup-shaped bottom 29 has at least one oil channel 30 which can be filled with pressure oil, e.g. hydraulic oil. The oil channel 30 communicates with pressure chambers 31, which are provided inside the cup-shaped wall 28. Viewed across the circumference of the cup-shaped wall 28, several pressure chambers 31 can be provided or a single circumferential pressure chamber, which is slot-shaped in cross-section, can be supplied with pressure oil, or in general with a pressure medium.

A residual wall 32 thus remains between the pressure chamber 31 and the peripheral surface 22 and has a wall thickness which is reduced compared to the cup-shaped wall 28. This residual wall 32 is elastically deformable radially outwards, when pressure fluid under excess pressure is present in the pressure chamber 31 (dashed line 33 in FIG. 3). As a result of the radial expansion of the residual wall 32, the peripheral surface 22 of the clamping device 12 comes into contact with the inner side 17 of the clamping jacket 13, so that the radially outwardly acting locking force Fₖ is generated. The level of the locking force Fₖ depends on the pressure of the pressure fluid in the pressure chambers 31 or the pressure chamber 31. By selecting a suitably high excess pressure in the pressure chamber 31, the column 3 can thus be clamped by means of the clamping device 12 with respect to the clamping jacket 13. To release the clamping action, i.e., to reduce the locking force Fₖ, it is only necessary to decrease the excess pressure in the pressure chamber 31, for example by opening a suitably arranged hydraulic valve (not shown). After the excess pressure in the pressure chamber 31 drops, the residual wall 32 reverts back elastically to its shape, so that the clamping device 12 is again supported to freely move along the opening and closing direction 9, as the sliding rings 27 rest upon the clamping jacket 13.

As already described above, the interior space 23 of the clamping jacket 13 can preferably be filled with air or oil. Particularly in the case of an oil filling, it is, of course, necessary to ensure suitable overflow openings or overflow passages so as to ensure a movement of the clamping device 12 within the clamping jacket 13 as unimpeded as possible. The embodiment of the clamping-type locking apparatus 2 according to FIG. 3 can be refined—as described above—by means of pressure cylinders 15 or pressure pads 16 to form a clamping unit 25. It is, of course, also possible, to employ other drives, for example lever drives, to provide the rapid travel of the platen 4, 5 relative to one another or the application of the clamping force. In such a case, the clamping-type locking apparatus 2 according to the invention and the corresponding devices for buildup of the clamping force form hereby the clamping unit 25.

A second embodiment of the clamping-type locking apparatus 2 according to the invention is shown in the upper sectional view above the column longitudinal axis 3a according to FIG. 4.

A third embodiment of the clamping-type locking apparatus 2 according to the invention is shown schematically in FIG. 4 in the lower sectional view, below the column longitudinal axis 3a.

Both embodiments of the clamping-type locking apparatus 2 according to the invention, as shown in FIG. 4, are constructed as wedge-type clamping apparatuses 40 with a clamping sleeve 41 and an actuating sleeve 42. The actuating sleeve 42 is arranged for hydraulic displacement in an axial direction 43 within a clamping chamber 44, which is formed in the cup-shaped wall 28 of the clamping device 12. In the embodiment according to FIG. 4, the clamping chamber 44 is open above the column longitudinal axis 3a toward the column 3, with the column 3 surrounding the clamping sleeve 41. The clamping sleeve 41 and the actuating sleeve 42 interact via a wedge or conical surface 45.

Via pressure oil lines 50, 51, which communicate with pressure oil chambers 52, 53, the actuation sleeve 42 can be slightly moved along the axial direction 43 toward the clamping sleeve 41 or away from the clamping sleeve 41 by appropriately acting upon the pressure oil chambers 52. When the actuating sleeve 42 is moved toward the clamping sleeve 41, a radially outwardly acting locking force Fₖ is generated, while the actuating sleeve 42 is supported on the cup-shaped wall 28 and the actuating sleeve 42 is supported on the wedge or conical surface 45, so that the cup-shaped wall 28 is elastically expanded and contacts with its circumferential surface 22 the inner side 17 of the clamping jacket 13, thereby building up the radially outwardly acting locking force Fₖ. To release the clamping action, the pressure oil chambers 52, 53 are pressurized with pressure oil or subjected to a pressure reduction, such that the actuating sleeve 42 is slightly moved away from the clamping sleeve 41 in axial direction 43. Thus, the cup-shaped wall 28 can slightly spring back radially inwards so as to release the clamping action.

The second embodiment of the clamping device 12 according to the invention as shown in FIG. 4 below the column longitudinal axis 3a uses the same operating principle of the wedge-type clamping apparatus 40, wherein the clamping chamber 44 is, however, open radially outwards towards the inner side 17 of the clamping jacket 13. The actuating sleeve 42 can also be moved slightly towards and away from the clamping sleeve 41 via pressure oil lines 50, 51 in axial direction 43 within the clamping chamber 44. For this purpose, the pressure oil chambers 52, 53 are accordingly pressurized with pressure oil or fluid under pressure. The clamping sleeve 41 rests radially on the outside upon the inner side 17 of the clamping jacket 13. In order to buildup the radially outwardly acting locking force Fₖ, the pressure oil chamber 53 is pressurized so as to slightly move the actuating sleeve 42 in axial direction 43 towards the clamping sleeve 41, so that the clamping sleeve 41 is slightly pressed radially outwardly via the wedge or conical surface 45 to thereby increase contact with the inner side 17 of the clamping jacket 13. This results in increased friction between the clamping sleeve 41 and the clamping jacket 13, so that the locking force Fₖ is generated. To release the clamping action, excess pressure is, for example, relieved from the clamping chamber 53, and the pressure chamber 52 is acted upon by the pressure oil, so that the actuating sleeve 42 is slightly moved away from the clamping sleeve 41 in axial direction 43. The clamping sleeve 41 thereby slightly decreases in diameter and again liberates the clamping device 12 relative to the clamping jacket 13.

The support of the clamping force Fₖ in the embodiment according to FIG. 4 (bottom) is assumed by the cup-shaped wall 28, which preferably rests flatly upon the column 3. The actuating sleeve 42 is hereby supported on a suitable support surface of the cup-shaped wall 28.

In the embodiment according to FIG. 4 (top), the locking force buildup is established by a radial expansion of the actuating sleeve 42, which causes a radial expansion of the cup-shaped wall 28, which radial expansion, however, can be reverted elastically.

In the embodiment according to FIG. 4 (bottom), a radial expansion of the clamping sleeve 41 is established, which radial expansion can be elastically reverted when the actuating sleeve 42 is correspondingly shifted within the clamping chamber 44.

In both embodiments according to FIG. 4, the clamping sleeve 41 and the actuating sleeve 42 as well as contact surfaces of the cup-shaped wall 28, which has a clamping chamber 44, thus act as wedge-type clamping device 55. The cup-shaped wall 28 together with the cup-shaped bottom 28 form hereby a housing 56 for receiving the wedge-type clamping device 55.

### REFERENCE SIGNS

1 injection molding machine
2 clamping-type locking apparatus
3 column
3a column longitudinal axis
4 first platen
5 second platen
6 first half-mold
7 second half-mold
8 machine bed
9 opening and closing apparatus
10 displacement cylinder
11 first end of 3
12 clamping device
13 clamping jacket
14 second end of 3
15 pressure cylinder
16 pressure pad
17 inner side
18 tubular body
19 first end of 13
20 second end of 13
21 end wall
22 peripheral surface
23 interior space
24 stripping device
25 clamping unit
26 bottom wall
27 sliding rings
28 cup-shaped wall
29 cup-shaped bottom
30 oil channel
31 pressure chamber
32 residual wall
33 dashed line
40 wedge-type clamping apparatus
41 clamping sleeve
42 actuating sleeve
43 axial direction
44 clamping chamber
45 wedge or conical surface
55 wedge-type clamping device
50, 51 pressure oil lines
52, 53 pressure oil chambers
55 wedge-type clamping device
56 housing
Fₖ locking force cm What is claimed is:

1.-10. (canceled)

11. A clamping unit of an injection molding machine having platens and columns, said clamping unit comprising a clamping-type locking apparatus by which a column is securable in relation to one of the platens at any position along a travel path of the platens relative to one another, said clamping-type locking apparatus including a clamping jacket and a clamping device for clamping-type locking of the column in relation to the clamping jacket, said clamping device being displaceable together with the column along the travel path within the clamping jacket, when the clamping device assumes a released state, said clamping device being configured to effect a clamping action by generating between the clamping jacket and the clamping device a locking force which is directed radially outwards in relation to a longitudinal axis of the column.

12. The clamping unit of claim 11, constructed for a two-platen injection molding machine.

13. The clamping unit of claim 11, wherein the clamping jacket is configured as tubular body which is grease-tight and/or dirt-tight and/or free of a release agent.

14. The clamping unit of claim 11, wherein the clamping jacket is fixed locally with respect to one of the platens.

15. The clamping unit of claim 11, wherein the clamping jacket is connected to the one of the platens, and further comprising a pressure element disposed between the pressure element and the clamping jacket.

16. The clamping unit of claim 15, wherein the pressure element is a pressure cylinder or a pressure pad.

17. The clamping unit of claim 11, wherein the clamping jacket has an interior space filled with air or oil.

18. The clamping unit of claim 11, wherein the clamping device has a pressure chamber configured for hydraulic supply with fluid to thereby pressurize the pressure chamber such as to expand radially elastically and thereby generate the locking force.

19. The clamping unit of claim 11, wherein the clamping device comprises a hydraulically actuatable wedge-type clamping apparatus which includes a clamping sleeve and an actuating sleeve, said actuating sleeve being arranged for hydraulic displacement in an axial direction within a housing of the clamping device and interacting with the clamping sleeve via a wedge or conical surface.

20. The clamping unit of claim 19, wherein the clamping device includes an open clamping chamber which points radially inwards towards the column for accommodating the actuating sleeve, said housing of the clamping device being expandable radially elastically by reaction forces applied by the wedge-type clamping device as the actuating sleeve moves relative to the clamping sleeve.

21. The clamping unit of claim 19, wherein the clamping device has an open clamping chamber which points radially outwards towards the clamping jacket for arrangement of the clamping sleeve to interact with an inner side of the clamping jacket by friction fit.

22. The clamping unit of claim 11, further comprising a stripping device provided in a region before a section of the column enters into an interior space of the clamping jacket for allowing stripping of grease and/or dirt and/or release agent from the column.
